(19) United States
(12) Patent Application Publication
(10) Pub. No.: US 2022/0130190 A1
(43) Pub. Date: Apr. 28, 2022

(54) SYSTEMS AND METHODS FOR PREMISES ACCESS CONTROL

(71) Applicant: SAFECARD ACCESS TECHNOLOGIES S.P.A., Santiago (CL)

(72) Inventors: Claudio JULIA, Santiago (CL); Alberto ROCHET, Santiago (CL)

(21) Appl. No.: 17/277,907

(22) PCT Filed: Oct. 8, 2018
(86) PCT No.: PCT/IB2018/057784

§ 371 Date: Mar. 19, 2021

(51) Int. Cl. G07C 9/00; G06K 19/06; G06K 7/14; G07C 9/27; H04W 12/08; H04W 12/63

(52) U.S. Cl. CPC G07C 9/00309; G06K 19/06037; G06K 7/1417; H04W 84/12; H04W 12/08; H04W 12/63; G07C 2209/04; G07C 9/27

(57) ABSTRACT

Systems and methods for premises access control are disclosed. A first request for a first user to access a premises is received by a first server and via a WAN (wide area network). The first request is received from a second server and the first server determines authorization. A second request for a second user to access the premises is received by the first server and via a WLAN (wireless local area network) associated with the first server. The second request is received from a mobile device that is associated with the second user and connected to the WLAN and the second user is determined to be authorized. A third request for a third user to access the premises is received by the first server. The third request is received from a physical access system configured to limit physical access to the premises and the third user is determined to be authorized.

### TECHNICAL FIELD

This disclosure generally relates to access control, and more particularly relates to multiple ways to enable access to premises depending on the network available to a user.

### BACKGROUND

Whether a business property, a residential sub-division, a condominium building, or even a single housing unit, owners and occupants place great importance on the physical security of such premises. Yet, occupants also demand convenient, prompt, and reliable access for themselves and their guests. However, the type of access control may be different for different types of occupants and visitors depending on the communication network available to them. Therefore, there is a need for a single, improved premises security system that can enable access to all types of occupants and visitors.

### SUMMARY

In one aspect, a first request for a first user to access a premises is received by a first server and via a WAN (wide area network). The first request is received from a second server. The first server is configured to determine authorization of access to the premises. The first user is determined to be authorized to access the premises. A second request for a second user to access the premises is received by the first server and via a WLAN (wireless local area network) associated with the first server. The second request is received from a mobile device that is associated with the second user and connected to the WLAN. The second user is determined to be authorized to access the premises. A third request for a third user to access the premises is received by the first server. The third request is received from a physical access system configured to limit physical access to the premises. The third user is determined to be authorized to access the premises.

Implementations may include one or more of the following features. The physical access system may be caused to allow entry to the first user to the premises based on the determining that the first user is authorized to access the premises. The physical access system may be caused to allow entry to the second user to the premises based on the determining that the second user is authorized to access the premises. The physical access system may be caused to allow entry to the third user to the premises based on the determining that the third user is authorized to access the premises.

The second request may comprise an indication that the mobile device associated with the second user is disconnected from a first mobile network enabling connection to the second server. The third request may comprise an indication that a mobile device associated with the third user is disconnected from a second mobile network enabling connection to the second server and an indication that the mobile device associated with the third user is disconnected from the WLAN.

The WLAN may comprise a Wi-Fi network. The first server may be connected to the WLAN. The third request may comprise a matrix barcode. The physical access system may comprise at least one of a barrier, a turnstile, a bulkhead, a lockable door, a gate, and a vehicle lift gate. The physical access system may comprise a matrix barcode reader and a user input device. The physical access system may comprise a vehicle identification system and the third request may comprise an identification of a vehicle associated with the third user.

A user access log may be updated to indicate at least one of: the determination that the first user is authorized to access the premises; the determination that the second user is authorized to access the premises; and the determination that the third user is authorized to access the premises.

A fourth user may be determined to not be authorized to access the premises. A notification that the fourth user is not authorized to access the premises may be sent.

Implementations of any of the described techniques may include a method or process, an apparatus, a device, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF DRAWINGS

The accompanying drawings, which are incorporated in and constitute a part of this specification, illustrate embodiments and together with the description, serve to explain the principles of the methods and systems:

FIG. 1 illustrates an example site in which premises access control may be implemented.

FIG. 2 illustrates an example system in which premises access control may be implemented.

FIG. 3 is a flow chart illustrating an example process for requesting user access to a premises.

FIG. 4 is a flow chart illustrating an example process for requesting user access to a premises.

FIG. 5 is a flow chart illustrating an example process for requesting user access to a premises.

FIG. 6 is a flow chart illustrating an example process for requesting user access to a premises.

FIG. 7 illustrates an example user interface associated with premises access control.

FIG. 8 illustrates an example user interface associated with premises access control.

FIG. 9 illustrates an example user interface associated with premises access control.

FIG. 10 illustrates an example user interface associated with premises access control.

FIG. 11 illustrates an example user interface associated with premises access control.

FIG. 12 illustrates an example user interface associated with premises access control.

FIG. 13 illustrates an example user interface associated with premises access control.

### DETAILED DESCRIPTION

The systems and methods of the present disclosure relate to premises access control. In general, a system may allow a user (e.g., a resident or occupant) access to a premises by use of his or her mobile device. The system may eliminate the need for a user to carry a physical key that would otherwise be necessary to access the premises, although the disclosure is not so limited. The system further provides redundant processes by which a user may access the premises depending upon the connectivity of the user's mobile device to various levels of wireless communication networks.

A user may initially operate his or her mobile device to request access via a mobile network (e.g., cellular network). This request via the mobile network is received by a cloud server. The cloud server relays the request to a control server, which may be local to the premises. The control server determines if the user is authorized to enter the premises. If so, the control server causes the appropriate physical access system (e.g., a door, gate, or the like) to unlock and allow user access.

In some cases, the initial process via the mobile network may be unsuccessful. For example, the user's mobile device may have lost cellular connectivity. The user instead may attempt authorization via a local wireless area network (WLAN) at the premises. In this case, the mobile device transmits the request for access to the control server via the WLAN. The control server again determines the user's authorization. If so authorized, the control server causes the physical access system to grant access to the user.

In yet other cases, both of the above techniques for requesting access via the mobile network and/or the WLAN may be unavailable. For example, the user's mobile device may experience malfunction in all wireless communication channels. In this case, the user may operate his or her mobile device to generate a bar code, such as a matrix bar code, on the mobile device display. The user presents the bar code shown on the display to a bar code reader associated with the physical access system. The bar code reader transmits the bar code or information represented by the bar code to the control server. The control server determines if the user is authorized to access the premises. If the user is so authorized, the control server causes the physical access system to grant entry to the user.

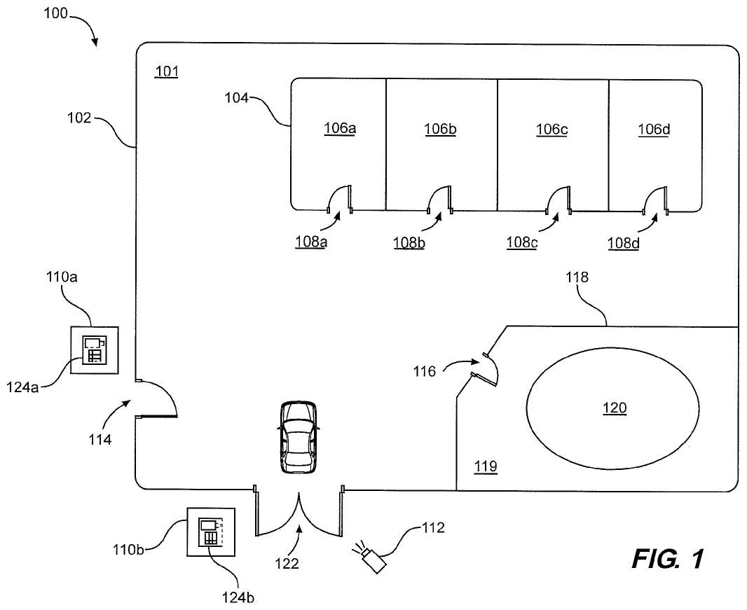

FIG. 1 illustrates an example site 100. Example sites may include a residential property, such as a residential subdivision or community, a multi-building apartment/condominium complex, an apartment/condominium building, or a single dwelling. Other example sites may include a business or commercial property, such as an office park, an office building, a shopping center, or a warehouse. The example site 100 shown in FIG. 1 may be characterized as a residential property, although the disclosure is not so limited.

The site 100 includes an outer perimeter boundary 102, such as a wall or fence, that secures a community space 101. Access through the outer perimeter boundary 102 to the community space 101 may be controlled by a physical access system 114 and/or a physical access system 122. The physical access system 114 may be realized as a gate or door, for example. The physical access system 122 may be configured to control vehicle access to the community space 101. As such, the physical access system 122 may be configured as a vehicle gate or lifting barrier. A license plate reader 112 may be situated proximate the physical access system 122 to detect the presence of a vehicle at the physical access system 122 and identify the vehicle's license plate numbers and/or characters. The license plate reader 112 may be considered part of the physical access system 122.

The community space 101 comprises a multi-unit dwelling 104. The multi-unit dwelling 104 may include an apartment or condominium building. Although not show in FIG. 1, the multi-unit dwelling 104 may have its own physical access system to limit access to the multi-unit dwelling 104 as a whole. The multi-unit dwelling 104 comprises several housing units 106a-d, each designed to house a single resident or family. Each housing unit 106a-d is equipped with a physical access system 108a-d, respectively, to secure the unit. The physical access systems 108a-d may be realized as lockable doors, for example.

The site 100 also includes a pool area 119, with pool 120, within the community space 101. The pool area 119 is bound by a fence 118 and a portion of the outer perimeter boundary 102. A physical access system 116, such as a lockable gate, may secure the pool area 119.

The site 100 includes several security kiosks 110a,b configured to facilitate secure access through the physical access system 114 and physical access system 122, respectively. Each security kiosk 110a,b is, accordingly, situated proximate the respective physical access system 114, 122. The security kiosks 110a,b may be considered a component of the respective physical access system 114, 122. Each security kiosk 110a,b is configured with a control panel 124a,b. Each control panel 124a,b may, in turn, be configured with a touchscreen and a bar code reader. Each control panel 124a,b may be further configured with a camera, speaker, and/or a keypad or other input device. Although not shown in FIG. 1, any physical access system may be complemented by a nearby security kiosk. And, as also not shown in FIG. 1, any physical access system may be equipped with a control panel to enjoy similar functionality as that provided by a security kiosk.

The security kiosks 110a,b may serve as an alternative or backup system for a resident or visitor to access the community space 101. For example, a resident may use one of the security kiosks 110a,b if she does not have her mobile device on her person. As another example, a resident may use one of the security kiosks 110a,b if his mobile device is not functioning correctly and is unable to connect to either the mobile network or the premises WLAN. As an example operation, a resident or visitor may present a bar code displayed on his or her mobile device to the bar code reader of the control panel 124a,b to gain access through the corresponding physical access system 114, 122. As another example operation, a resident or visitor may enter a PIN or other personal credentials via the control panel 124a,b to gain access to the community space 101.

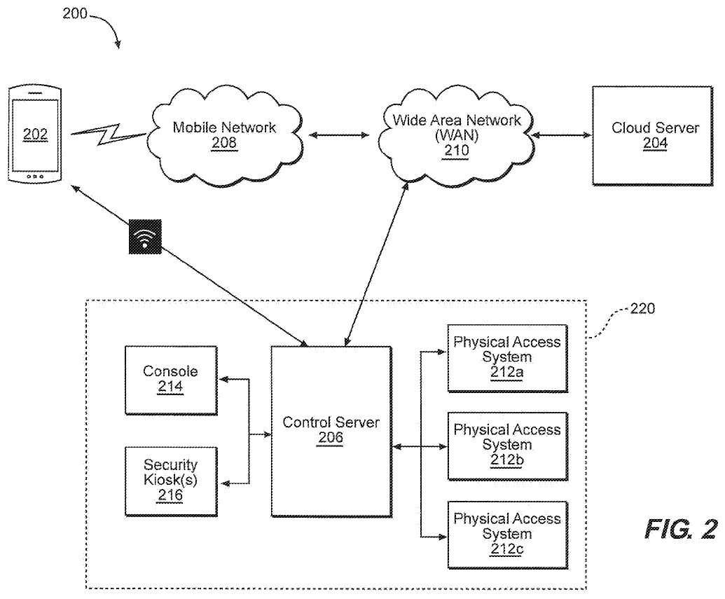

FIG. 2 shows an example system 200 in which the disclosed systems and methods may be implemented. In particular, the system 200 may facilitate access control of an associated premises. As used herein, a premises shall be understood to include any space to which access may be controlled. For example, a premises may include a land property, such as a residential community or subdivision, an apartment/condominium complex, or an office park. A premises may further include a building, such as an office building, a home, or an apartment/condominium building. A premises may yet further include a room or other space within a building, such as a conference room, data center, or laboratory. The community space 101, the housing units 106a-d, and the pool area 119 in FIG. 1 are each examples of a premises.

The system 200 includes a user's mobile device 202, a cloud server 204, and a control server 206. The mobile device 202, the cloud server 204, and the control server 206 may be interconnected, at various times and in various capacities, via a mobile network 208, a wide area network (WAN) 210, and/or a WLAN 220. The mobile network 208 may be implemented as a cellular network, for example. The WAN 210 may include the Internet. In some aspects, the mobile network 208 may be integrated within the WAN 210. The WLAN 220 may be implemented according to the IEEE 802.11 standard. The WLAN may include a Wi-Fi network, for example. The WLAN 220 may also include wired connections in addition to wireless communication channels.

In some implementations, the system 200 may include two WLANs. One WLAN may be used for communication between the on-premises security system components, at the exclusion of user devices, such as the mobile device 202. Another WLAN may be made available for public use, such as by the user and his or her mobile device. The control server 206 may bridge communications between the two WLANs.

The mobile device 202 may be realized as a smartphone, tablet computer, portable gaming device, or other similar computing device designed for carry on a user's person. The mobile device 202 may be configured with one or more communication interfaces, including wireless and wired. For example, the mobile device 202 may include a cellular interface configured to connect to and communicate via the mobile network 208. As another example, the mobile device 202 may include a radio transceiver configured to connect to and communicate via the WLAN 220.

The mobile device 202 may be further configured with one or more processors and memory, volatile and non-volatile. The memory may store instructions that, when executed by the one or more processors, effectuate any of the methods and techniques described herein. The memory may further store instructions to execute, by the one or more processors, an operating system and one or more applications. Such applications may include one or more applications configured to interact with the system 200 and components thereof. For example, an application may be configured to request access to a premises, present a barcode or other authentication information via a display of the mobile device 202, and/or receive feedback responsive to the request for access.

The mobile device 202 may include one or more output components, such as a display and/or speaker. The mobile device 202 may further include one or more input components, such as a touchscreen, keypad, and/or a microphone.

The cloud server 204 is realized as one or more networked computing devices and is configured to exchange communications, via the WAN 210, with the mobile device 202. Such communications may include requests for premises access from the mobile device 202, as well as feedback to such requests that are sent to the mobile device 202. The cloud server 204 additionally communicates, via the WAN 210, with the control server 206. The communications with the control server 206 may be further effectuated via the WLAN 220 in some cases. The cloud server 204 may communicate requests for premises access, originated from the mobile device 202, to the control server 206, for example.

The control server 206 is also realized as one or more networked computing devices. The control server 206 is generally configured to manage access control to the premises. For example, the control server 206 may receive a request for premises access and determine if the requesting user is authorized. Depending on whether the user is authorized for access, the control server 206 will execute one or more processes and/or actions accordingly. For example, the control server 206 may cause a physical access system to grant the user access. In some implementations, some or all of the functionality and logic performed by the control server 206 may be shifted to or shared with the cloud server 204. For example, the cloud server 204 may determine if a user is authorized to access the premises and communicate this determination to the control server 206. In some implementations, the control server 206 and the cloud server 204 may be integrated as a single system.

The control server 206 may be directly connected to the WLAN 220, as shown in FIG. 2. In other aspects, the control server 206 may connect to the WLAN 220 via an intermediary computing device that is directly connected to the WLAN 220. Relatedly, the control server 206 may be located at the premises, such as in those instances in which the control server 206 directly connects to the WLAN 220. In some aspects, the control server 206 may be located external to the premises, such as in those instances in which the control server 206 only connects to the WLAN 220 via an intermediary device.

In the same or similar manner as the mobile device 202, the cloud server 204 and the control server 206 may be each configured with one or more processors and memory. The memory may store instructions that, when executed by the one or more processors, effectuate any of the methods and techniques described herein.

Also connected to the WLAN 220 are physical access systems 212a-c, a console 214, and a security kiosk(s) 216. The physical access systems 212a-c, console 214, and security kiosk(s) 216 are further connected to the control server 206, such as via the WLAN 220.

The physical access systems 212a-c may comprise a barrier, a turnstile, a bulkhead, a lockable door, a gate, a vehicle lift gate, or other mechanisms to limit physical access. In some implementations, a license plate reader (e.g., the license plate reader 112 in FIG. 1) may be incorporated as part of one or more of the physical access system 212a-c. The physical access systems 212a-c may be configured with a control panel comprising a barcode (e.g., matrix barcode) reader and an input device, such as a touchscreen. The control panel may facilitate access through the respective physical access system 212a-c, such as when a user is unable to connect to the mobile network 208 to request access. The physical access systems 114, 122 to the community space 101, the physical access system 116 to the pool area 119, and the physical access systems 108a-d shown in FIG. 1 are each examples of the physical access systems 212a-c. As an example, the physical access systems 212a-c are configured to receive an instruction from the control server 206 to open and allow user access to the premises or to remain locked or secured to deny user access to the premises.

The console 214 is realized as one or more networked computing devices. The console 214 is used by personnel associated with the premises (e.g., a security guard or administrator). The console 214 may be used to bypass or override an instruction from the control server 206. For example, the console 214 may cause one of the physical access systems 212 to unlock despite a contrary instruction from the control server 206. The console 214 may store logs indicating activity of the system 200. For example, the logs may indicate a time that a request for access was received and the requester. Personnel may operate the console 214 to view the logs. The console 214 further may facilitate invitations for visitors to be allowed access to the premises. The console 214 may be used to register users, including normal occupants, as well as guests or visitors. Upon registration, the user may be issued a personal ID, such as a PIN.

The security kiosk(s) 216 are associated with one or more of the physical access systems 212a-c and facilitate access to the premises via the associated physical access system 212a-c. The security kiosks 110a,b in FIG. 1 are examples of the security kiosk(s) 216. The security kiosk(s) 216 are equipped with a control panel, similar to those described with respect to the physical access systems 212a-c. Thus, the control panels comprise a bar code reader and a touchscreen or other input component. The security kiosk(s) 216 may be considered part of the associated physical access system 212a-c. In some implementations, the security kiosk(s) 216 may be integrated with the associated physical access system 212a-c.

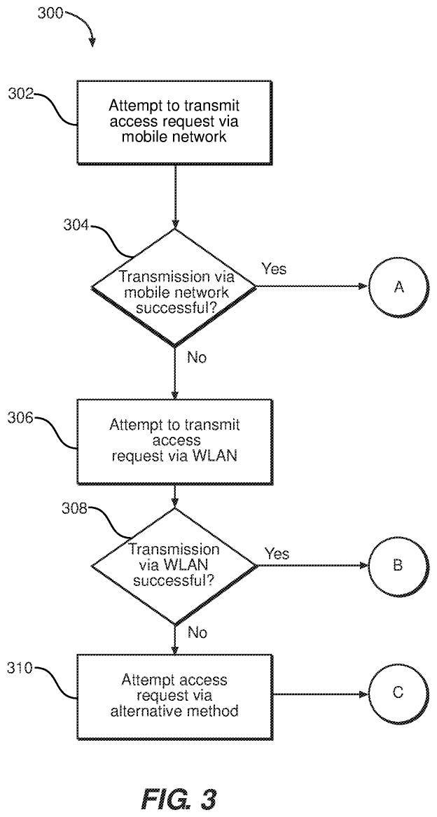

FIG. 3 shows a flow chart 300 to manage, at least in part, user access to a premises. At step 302, a user attempts to transmit a request for access to a premises (e.g., the community space 101, the pool area 119, and the housing units 106a-d in FIG. 1) via an associated mobile network (e.g., the mobile network 208 in FIG. 2). The target recipient of the access request is a cloud server (e.g., the cloud server 204 in FIG. 2) associated with the security system. The target recipient of the access request (whether via the cloud server or not) is a control server (e.g., the control server 206 in FIG. 2) associated with the security system. As an example, the user operates her mobile device to generate the access request and attempt to transmit the access request via the associated mobile network. The user may operate, on her mobile device, an application associated with the security system of the premises to generate and attempt to transmit the access request to the cloud server via the mobile network.

The user may be a resident or occupant of the premises. The access request may be associated with a particular physical access system (e.g., the physical access systems 114, 122, 116, 108a-d in FIG. 1 and/or the physical access system 212a-c in FIG. 2). For example, the user may be situated near a physical access system and, thus, request access to the premises through that physical access system. The access request may indicate the particular physical access system for which access is requested. Whether the user is granted access to the premises may depend on the physical access system identified in the access request. For example, a user may be authorized to enter via a pedestrian physical access system but not a vehicle physical access system.

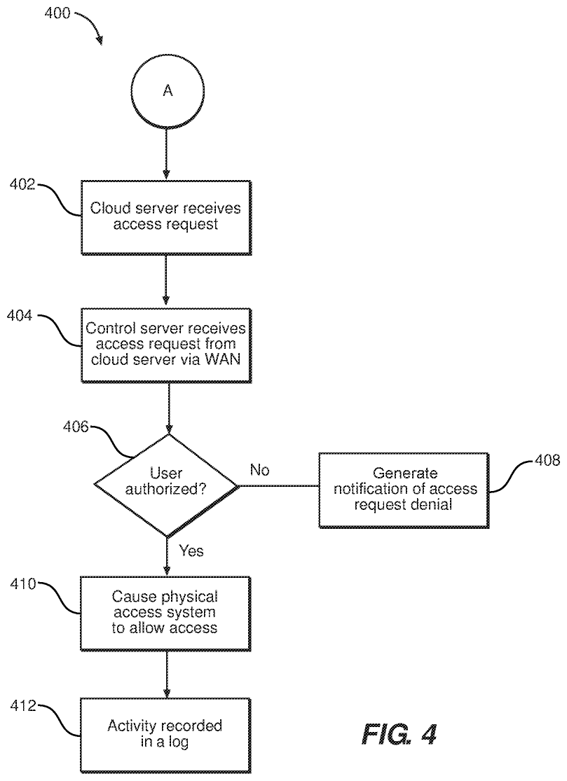

At step 304, a determination is executed as to whether the transmission of the access request via the mobile network was successful. The determination may comprise determining if the mobile device is or was properly connected to the mobile network. The determination may comprise determining if the access request is or was received by the cloud server. The determination may comprise determining if the access request is or was received by the control server via the mobile network. The determination of whether the transmission of the access request via the mobile network was successful may be performed by the mobile device, for example, or other component of the security system such as the cloud server or the control server. If the transmission via the mobile network was successful, the flow chart 300 (e.g., the method) proceeds, indicated by the element A, to the flow chart 400 in FIG. 4. If the transmission via the mobile network was not successful, the flow chart 300 continues to step 306.

At step 306, the user attempts to transmit the access request via a WLAN (e.g., the WLAN 220) associated with the premises. For example, the user operates her mobile device (e.g., the associated application on her mobile device) to cause the mobile device to attempt to transmit the access request via the WLAN. The user may attempt to transmit the access request, via the WLAN, to the control server. The control server may be directly connected to the WLAN or may be connected via an intermediary computing device that is directly connected to the WLAN. The attempt to transmit the access request may be made according to the 802.11 standard (e.g., Wi-Fi).

In some instances, the WLAN to which the on-premises security components are connected may be different than the WLAN to which the mobile device connects. That is, the security system components are isolated, with respect to on-premises WLAN communication, from user devices. The control server may be connected to both WLANs to receive communications from both the mobile device via a first WLAN and communicate with the physical access systems, security kiosks, etc. via a second WLAN.

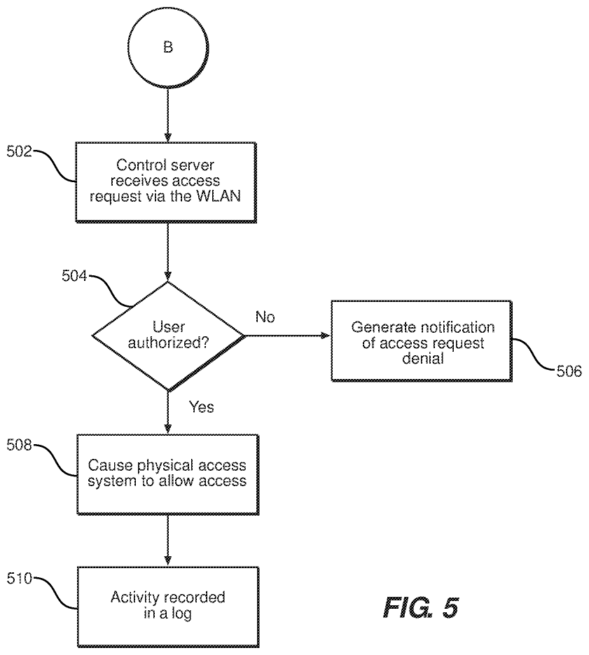

At step 308, a determination is executed as to whether the transmission of the access request via the WLAN was successful. The determination of whether the transmission via the WLAN was successful may comprise determining if the mobile device is or was connected to the WLAN. The determination may comprise determining if the access request was received by the control server. The determination of whether the transmission of the access request via the WLAN was successful may be performed by the mobile device, for example, or other component of the security system such as the control server. If the transmission via the WLAN was successful, the flow chart 300 (e.g., the method) proceeds, indicated by the element B, to the flow chart 500 in FIG. 5. If the transmission via the WLAN was not successful, the flow chart 300 continues to step 310.

At step 310, the user attempts to request access to the premises via one or more alternative methods. In some cases, these methods may be the default access methods for some users. For example, a visitor may not have a mobile device on his or her person. Or if the visitor does have his or her mobile device, the application associated with the security system may not be installed on the mobile device. As another example, a normal resident may have lost or forgotten his or her mobile device.

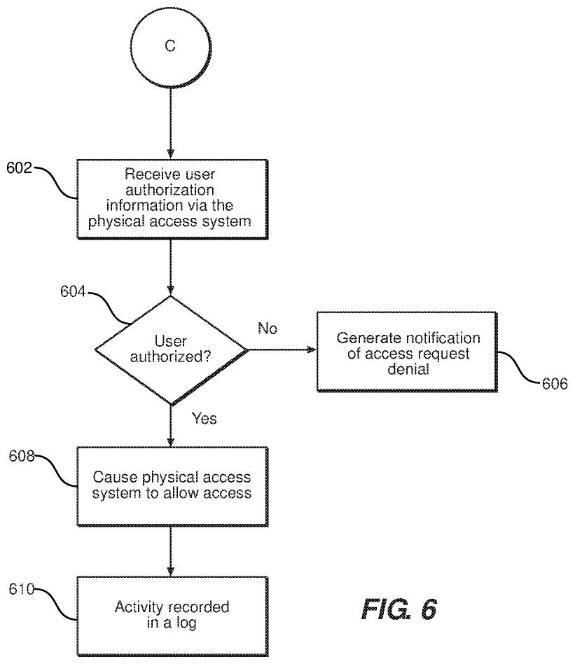

As an example, the user may attempt to request access by presenting a bar code (e.g., a matrix barcode, such as a QR barcode) to a bar code reader associated with the security system. The bar code reader may be that of a security kiosk (e.g., the security kiosks 110a,b in FIG. 1 and/or the security kiosk(s) 216 in FIG. 2) and/or a physical access system. As another example, the user may attempt to request access by providing an identifier or authorization code to the security system. This may be provided via a control panel of a security kiosk or physical access system. As another example, the user may drive her vehicle to a physical access system designed for vehicle access (e.g., the physical access system 122 in FIG. 1). An associated license plate reader (e.g., the license plate reader 112 in FIG. 1) may identify the license plate number of the user's vehicle. The license plate number may serve as the user's personal identifier. Following the attempt to request access via one or more of the alternative methods, the flow chart 300 proceeds, indicated by element C, to the flow chart 600 in FIG. 6.

FIG. 4 shows the flow chart 400, which continues the flow chart 300 at element A. At step 402, the cloud server receives the access request from the mobile device. The access request may have been transmitted to the cloud server via a WAN (e.g., the WAN 210 in FIG. 2) in addition to the mobile network. The cloud server transmits the access request (or other message indicating the access request) to the control server via the WAN.

At step 404, the control server receives the access request, via the WAN, from the cloud server. At step 406, the control server determines if the user is authorized to access the premises. The control server may further determine if the user is authorized to access the premises via the physical access system that may be indicated in the access request, if the system is so implemented. In some implementations, a system component other than the control server may determine if the requesting user if authorized. For example, the cloud server may perform this determination and indicate the result to the control server. The control server may receive the authorization result and proceed accordingly.

If the user is authorized, the flow chart 400 proceeds to step 410. If the user is not authorized, the flow chart 400 proceeds to step 408.

At step 408, a notification is generated that indicates that the access request is denied. The notification may be transmitted, such as to the user's mobile device. The mobile device may present the notification via the application executing on the mobile device and associated with the security system. The notification may be transmitted to the mobile device via the mobile network. The notification may be generated and/or transmitted by the control server. The notification may be transmitted to the mobile device by way of the cloud server. In some aspects, the cloud server may originate and transmit the notification to the user's mobile device. In some aspects, the notification of denial may be indicated to the user by presentation on a display or touchscreen proximate the physical access system. In yet other aspects, the denial notification may be communicated to the user via email and/or text message. The denial of the access request may be recorded in a log, including the time of the access request, the requesting user, and the requested physical access system.

At step 410, the physical access system (e.g., the physical access system indicated in the access request) is caused to allow access by the user to the premises. The control server may cause the physical access system to allow access. The control server may transmit an instruction to the physical access system to allow the access. The instruction to the physical access system may comprise an instruction for the physical access system to unlock and/or open. The grant of access may be indicated to the user via the application executing on the mobile device or via a display or touchscreen proximate the physical access system. At step 412, the grant of access may be recorded in a log, including the time of the access request, the requesting user, and the requested physical access system.

FIG. 5 shows the flow chart 500, which continues the flow chart 300 at element B. At step 502, the control server receives the access request. The control server may receive the access request via the WLAN. The control server may receive the access request via the WAN in additional to the WLAN, such as if the control server is located external the premises or is not directly connected to the WLAN.

At step 504, the control server determines if the user is authorized to access the premises. The control server may further determine if the user is authorized to access the premises via the physical access system that may be indicated in the access request, if the system is so implemented. In some implementations, a system component other than the control server may determine if the requesting user if authorized. For example, the control server may relay the request to the cloud server for the cloud server to determine if the user is authorized. The cloud server may make such a determination and return the result back to the control server. The control server may then proceed accordingly.

If the user is authorized, the flow chart 500 proceeds to step 508. If the user is not authorized, the flow chart 500 proceeds to step 506.

At step 506, a notification is generated that indicates that the access request is denied. The notification may be transmitted, such as to the user's mobile device. The mobile device may present the notification via the application executing on the mobile device and associated with the security system. The notification may be transmitted to the mobile device via the WLAN. The notification may be generated and/or transmitted by the control server. In some aspects, the notification of denial may be indicated to the user by presentation on a display or touchscreen proximate the physical access system. In yet other aspects, the denial notification may be communicated to the user via email and/or text message. The denial of the access request may be recorded in a log, including the time of the access request, the requesting user, and the requested physical access system.

At step 508, the physical access system (e.g., the physical access system indicated in the access request) is caused to allow access by the user to the premises. The control server may cause the physical access system to allow access. The control server may transmit an instruction to the physical access system to allow the access. The instruction to the physical access system may comprise an instruction for the physical access system to unlock and/or open. The grant of access may be indicated to the user via the application executing on the mobile device or via a display or touchscreen proximate the physical access system. At step 510, the grant of access may be recorded in a log, including the time of the access request, the requesting user, and the requested physical access system.

FIG. 6 shows the flow chart 600, which continues from the flow chart 300 at element C. At step 602, authorization information is received via a physical access system. The physical access system may receive the authorization information and transmit this to the control server. The physical access system may transmit the authorization information to the control server via the WLAN. The authorization information may indicate or otherwise be understood to indicate the request for access by the user. The authorization information may take one or several different forms and/or be received by one of several different mechanisms.

For example, the authorization information may comprise a barcode (e.g., a matrix barcode) shown on a display of the mobile device and read by a barcode reader. The barcode reader may be that of a physical access system or an associated security kiosk. The barcode may identify the user. Additionally or alternatively, the barcode may indicate a passcode, including a dynamically generated passcode. The mobile device and/or application executing thereon may dynamically generate the barcode. The passcode may be derived from a cryptographic key, in a similar manner as implemented in a security token.

As another example, a user may provide a personal identifier and/or an authorization code. The personal identifier and/or authorization code may be entered via a keypad and/or touchscreen. A physical access system and/or an associated security kiosk may supply the keypad and/or touchscreen The personal identifier may have been previously registered in the security system. When the control server receives the personal identifier, it recognizes the associated user and grants the user access. The authorization code may be a static authorization code. Or, like the code that may be indicated by the barcode, the authorization code may be dynamically generated based on a cryptographic key.

As yet another example, a license plate reader may identify the license plate numbers and/or characters of the license plate of the user's vehicle. This may occur when the vehicle pauses or stops upon approaching a vehicle physical access system. The license plate numbers and/or characters may serve as a personal identifier of the user.

At step 604, the control server determines if the user is authorized to access the premises. The control server may further determine if the user is authorized to access the premises via the physical access system from which the user generated the access request. In some implementations, a system component other than the control server may determine if the requesting user if authorized. For example, the control server may relay the request to the cloud server for the cloud server to determine if the user is authorized. The cloud server may make such a determination and return the result back to the control server. The control server may then proceed accordingly.

If the user is authorized, the flow chart 600 proceeds to step 608. If the user is not authorized, the flow chart 600 proceeds to step 606.

At step 606, a notification is generated that indicates that the access request is denied. The notification of denial may be indicated to the user by presentation on a display or touchscreen proximate the physical access system. In yet other aspects, the denial notification may be transmitted. For example, the denial notification may be communicated to the user via email and/or text message. The denial of the access request may be recorded in a log, including the time of the access request, the requesting user, and the requested physical access system.

At step 608, the physical access system (e.g., the physical access system via which access was requested) is caused to allow access by the user to the premises. The control server may cause the physical access system to allow access. The control server may transmit an instruction to the physical access system to allow the access. The instruction to the physical access system may comprise an instruction for the physical access system to unlock and/or open. The grant of access may be indicated to the user via a display or touchscreen proximate the physical access system. At step 610, the grant of access may be recorded in a log, including the time of the access request, the requesting user, and the requested physical access system.

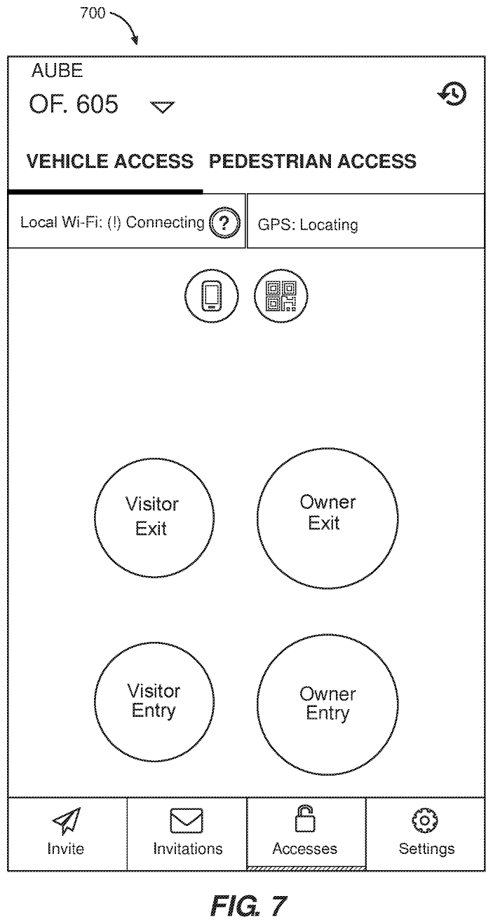

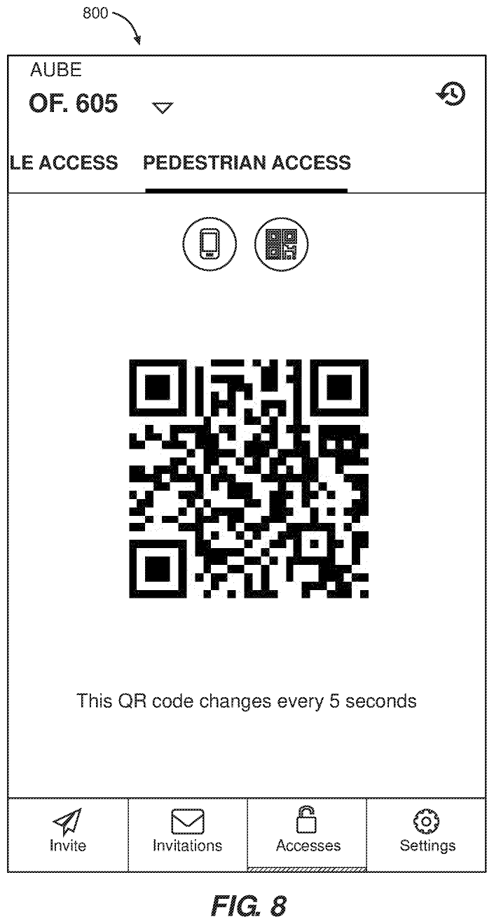

FIGS. 7-13 illustrate example user interfaces 700-1300 via which premises access control may be, at least in part, implemented with respect to a premises. For example, the user interface 700 comprises interface elements selectable to initiate entry and/or access to the premises. The user interface 700 further comprises interface elements selectable to manage vehicle access to the premises or pedestrian access to the premises. The user interface 700 indicates a connection status to a network, such as a WAN or WLAN. FIG. 8 illustrates the user interface 800 displaying a matrix barcode. The matrix barcode may be presented to a barcode reader associated with a physical access system to gain access to the premises via the physical access system, for example.

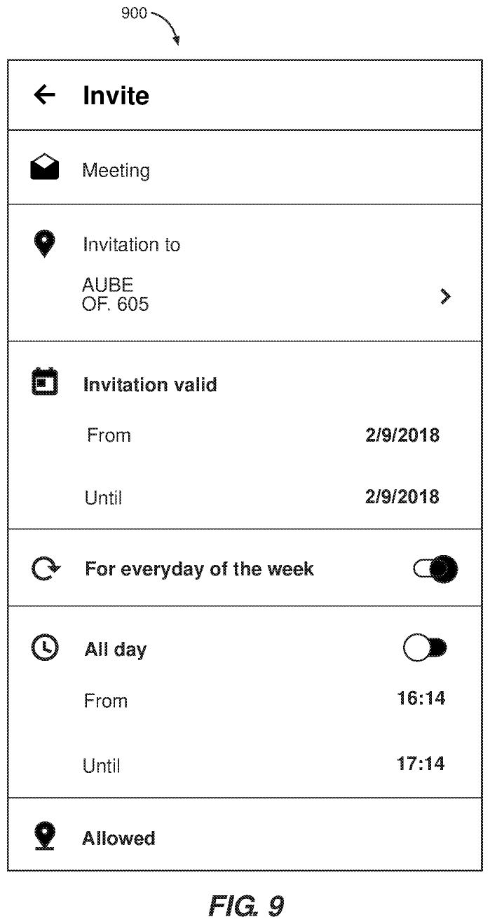

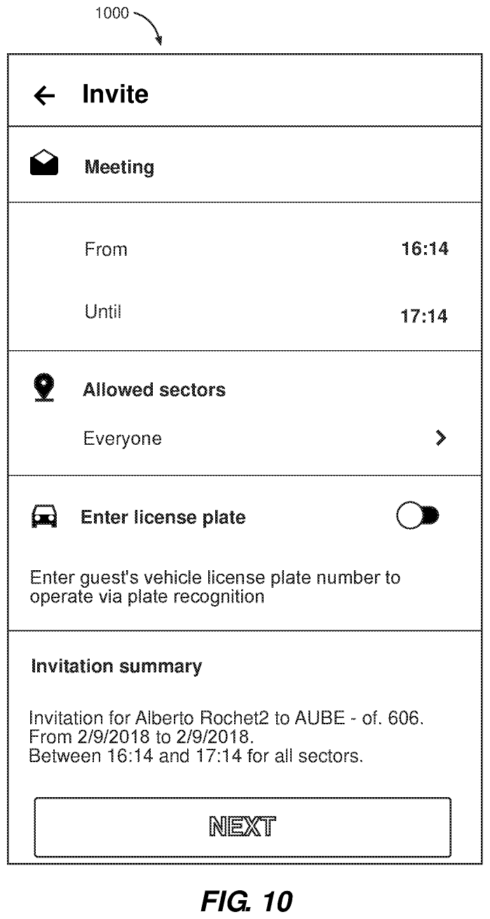

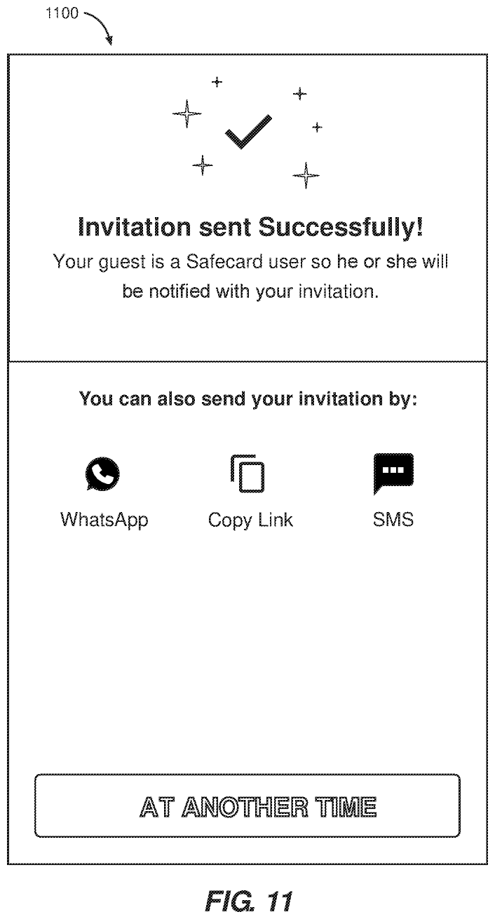

FIGS. 9-11 illustrate user interfaces at various stages of a process to configure access for and invite another user to the premises. In FIG. 9, the user interface 900 comprises interface elements via which the user may specify the premises and the time period that the invitation will be valid. FIG. 10 illustrates the user interface 1000. The user interface 1000 indicates a meeting associated with the invitation and a summary of the invitation. The user interface 1000 further comprises interface elements to indicate allowable sectors of the premises and to indicate that the user is to arrive via vehicle and authorized using a license plate reader. FIG. 11 illustrates the user interface 1100. The user interface 1100 indicates that the invitation was successfully sent. The user interface 1100 further comprises interface elements that the user may select to specify another application or method that the invitation is to be sent to the invitee. The user interface 1100 further comprises an interface element to initiate entry of another time or begin a new invitation.

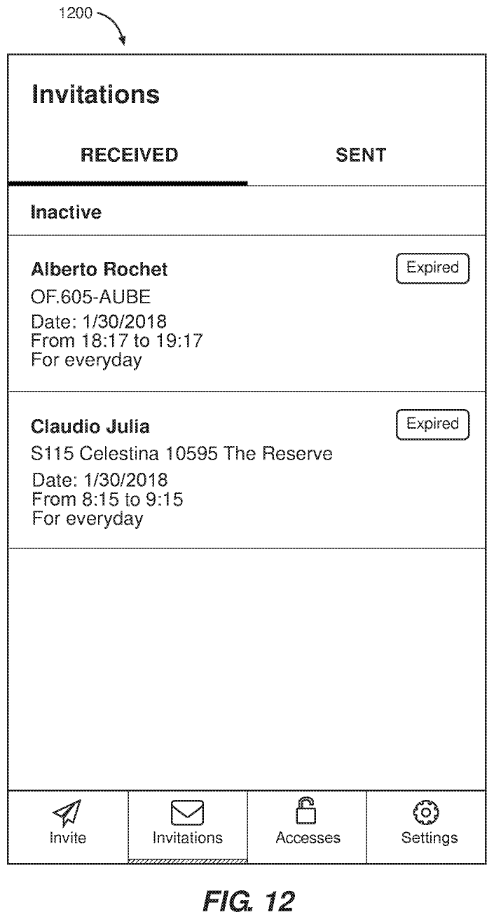

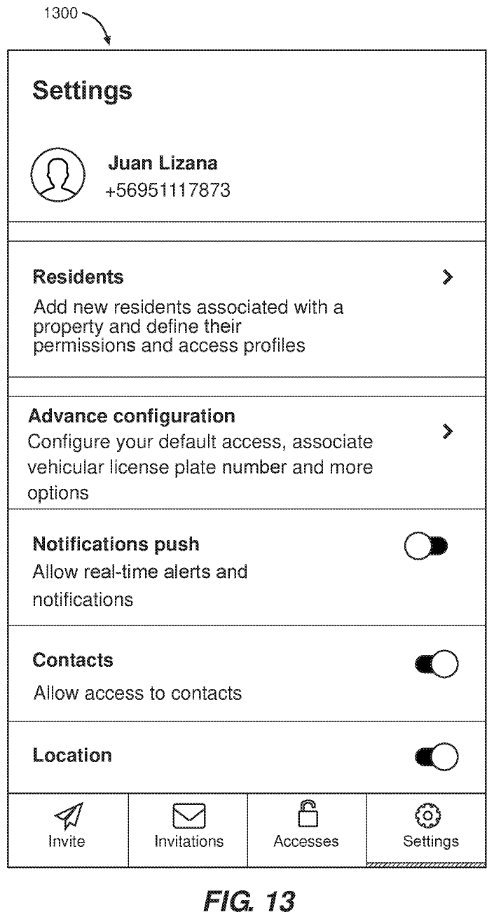

FIG. 12 illustrates the user interface 1200 that indicates invitations (and associated details) that have been previously received by the user and the status of those invitations. FIG. 13 illustrates the user interface 1300 configured to modify aspects of the application generating the user interfaces and aspects of the associated premises access control system. For example, the user interface 1300 comprises an interface element configured to initiate a process to add new residents of the premises and define their access.

The described system may also be extended to accommodate visitors to the premises. For example, a console (e.g., the console 214 in FIG. 2) may register a visitor. The visitor may be provided a personal identifier and/or authorization code. Additionally or alternatively, a resident user may operate the application on his or her mobile device to send an invitation to the contemplated visitor. The invitation may be sent to the visitor's phone number, for example. If the visitor has the application installed on his or her mobile device, that application may receive the invitation. Based on the invitation, the application may be then configured to generate and display a barcode that will allow the visitor access to the premises. Additionally or alternatively, the application on the visitor's mobile device may request, based on the invitation, access to the premises via a mobile network or the on-premises WLAN. This is similar to the process performed by the resident, but the visitor access request also indicates the inviting resident for cross-authentication. The invitation to the visitor and the resultant access privileges may be limited by date and time and/or a pre-defined schedule.

The described system may also be extended to control and log exit from a premises. For example, a user may be required to undergo a similar process to exit the premises at that required to enter the premises. The system may log that the user has entered the premises. When the user attempts to leaves the premises (i.e., submits a request to exit) the user must be first authorized. The processes for determining the authorization to exit and effectuating that exit may be implemented in a same or similar manner as those used to authorize entrance to the premises. For example, if the user is not authorized, the user is notified of the denial. If the user is authorized, the system (e.g., the control server) instructs the appropriate physical access system to allow exit. The request to exit, including the time of the request, the requesting user, and the time of exit, may be recorded in a log.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is not intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is not intended that an order be inferred, in any respect.

It will be apparent to those skilled in the art that various modifications and variations may be made without departing from the scope or spirit of this application. Other embodiments will be apparent to those skilled in the art from consideration of the specification and practice disclosed herein.

What is claimed is:

1. A method of managing access to premises, the method comprising:
receiving, by a first server, via a WAN (wide area network), and from a second server, a first request for a first user to access the premises, wherein the first server is configured to determine authorization of access to the premises.
determining, based on the first request, that the first user is authorized to access the premises;
receiving, by the first server, via a WLAN (wireless local area network) associated with the first server, and from a mobile device associated with a second user and connected to the WLAN, a second request for the second user to access the premises;
determining, based on the second request, that the second user is authorized to access the premises;
receiving, by the first server, and from a physical access system configured to limit physical access to the premises, a third request for a third user to access the premises; and
determining, based on the third request, that the third user is authorized to access the premises.

2. The method of claim 1, further comprising:
based on the determining that the first user is authorized to access the premises, causing the physical access system to allow entry of the first user to the premises;
based on the determining that the second user is authorized to access the premises, causing the physical access system to allow entry of the second user to the premises; and
based on the determining that the third user is authorized to access the premises, causing the physical access system to allow entry of the third user to the premises.

3. The method of claim 2, wherein:
the second request comprises an indication that the mobile device associated with the second user is disconnected from a first mobile network enabling connection to the second server, and
the third request comprises an indication that a mobile device associated with the third user is disconnected from a second mobile network enabling connection to the second server and an indication that the mobile device associated with the third user is disconnected from the WLAN.

4. The method of claim 1, wherein the WLAN comprises a Wi-Fi network.

5. The method of claim 1, wherein the first server is a connected to the WLAN.

6. The method of claim 1, wherein the third request comprises a matrix barcode.

7. The method of claim 1, further comprising:
updating a user access log to indicate at least one of:
the determination that the first user is authorized to access the premises,
the determination that the second user is authorized to access the premises, and
the determination that the third user is authorized to access the premises.

8. The method of claim 1, further comprising:
determining that a fourth user is not authorized to access the premises; and
sending a notification that the fourth user is not authorized to access the premises.

9. The method of claim 1, wherein the physical access system comprises at least one of a barrier, a turnstile, a bulkhead, a lockable door, a gate, and a vehicle lift gate.

10. The method of claim 9, wherein the physical access system further comprises a matrix barcode reader and a user input device.

11. The method of claim 1, wherein the physical access system comprises a vehicle identification system and the third request comprises an identification of a vehicle associated with the third user.

12. A system comprising:
a physical access system configured to limit physical access to a premises;
a first server associated with the premises and in communication with the physical access system, wherein the first server is configured to:
receive, via a WAN (wide area network), and from a second server, a first request for a first user to access the premises;
determine, based on the first request; that the first user is authorized to access the premises;
receive, via a WLAN (wireless local area network) associated with the first server, and from a mobile device connected to the WLAN, a second request for a second user to access the premises;
determine, based on the second request, that the second user is authorized to access the premises;
receive, by the first server, and from a physical access system configured to limit physical access to the premises, a third request for a third user to access the premises; and
determine, based on the third request, that the third user is authorized to access the premises.

13. The system of claim 12, wherein the first server is further configured to:
based on the determination that the first user is authorized to access the premises, cause the physical access system to allow entry of the first user to the premises;
based on the determination that the second user is authorized to access the premises, cause the physical access system to allow entry of the second user to the premises; and
based on the determination that the third user is authorized to access the premises, cause the physical access system to allow entry of the third user to the premises.

14. The system of claim 13, wherein:
the second request comprises an indication that the mobile device associated with the second user is disconnected from a first mobile network enabling connection to the second server, and
the third request comprises an indication that a mobile device associated with the third user is disconnected from a second mobile network enabling connection to the second server and an indication that the mobile device associated with the third user is disconnected from the WLAN.

15. The system of claim 12, wherein the WLAN comprises a Wi-Fi network and the first server is a component of the WLAN.

16. The system of claim 12, wherein the third request comprises a matrix barcode.

17. The system of claim 12, wherein:
the physical access system comprises at least one of a barrier, a turnstile, a bulkhead, a lockable door, a gate, and a vehicle lift gate, and
the physical access system further comprises a matrix barcode reader and a user input device.

18. A computer-readable medium storing instruction that, when executed by one or more processors, effectuate operations comprising:
receiving, by a first server, via a WAN (wide area network), and from a second server, a first request for a first user to access a premises, wherein the first server is configured to determine authorization of access to the premises;
determining, based on the first request, that the first user is authorized to access the premises;
receiving, by the first server, via a WLAN (wireless local area network) associated with the first server, and from a mobile device associated with a second user and connected to the WLAN, a second request for the second user to access the premises;
determining, based on the second request, that the second user is authorized to access the premises;
receiving, by the first server, and from a physical access system configured to limit physical access to the premises, a third request for a third user to access the premises; and
determining, based on the third request, that the third user is authorized to access the premises.

19. The computer-readable medium of claim 18, wherein the operations further comprise:
based on the determining that the first user is authorized to access the premises, causing the physical access system to allow entry of the first user to the premises;
based on the determining that the second user is authorized to access the premises, causing the physical access system to allow entry of the second user to the premises; and
based on the determining that the third user is authorized to access the premises, causing the physical access system to allow entry of the third user to the premises.

20. The computer-readable medium of claim 19, wherein:
the second request comprises an indication that the mobile device associated with the second user is disconnected from a first mobile network enabling connection to the second server, and
the third request comprises an indication that a mobile device associated with the third user is disconnected from a second mobile network enabling connection to the second server and an indication that the mobile device associated with the third user is disconnected from the WLAN.
